(19) United States
(12) Patent Application Publication
(10) Pub. No.: US 2006/0175895 A1
(43) Pub. Date: Aug. 10, 2006

(54) Hydraulic brake system with anti-lock control

(75) Inventors: Rudiger Mahlo, Berlin (DE); Andreas Kohl, Mainz (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG

(21) Appl. No.: 11/396,446

(22) Filed: Apr. 3, 2006

(30) Foreign Application Priority Data
Feb. 4, 2005 (DE) 10 2005 015 158.2
Feb. 2, 2006 (DE) P 10 2006004745.1

(51) Int. Cl. B60T 13/18

(52) U.S. Cl. 303/11

(57) ABSTRACT

A hydraulic brake system with anti-lock brake control has a variable-speed electromotor for driving the return pump (9) to drain the low-pressure accumulators (8), which accommodates pressure fluid discharged from the wheel brakes (5) during a slip-controlled braking. An electronic controller and solenoid valves (4, 7) modulate the brake pressure in the wheel brakes (5) of the slip-controlled wheels individually for each wheel in dependence on wheel rotation behavior. The electronic controller includes a module to change the speed of the electromotor, wherein the nominal speed of the electromotor is set or controlled in dependence on the filling level in the at least one of the low-pressure accumulators (8), and possibly the prevailing pressure in the brake system. Thus, an unadjusted motor speed, which can lead to overspeeding of the motor when no fluid is present in the low-pressure accumulator, is eliminated.

### BACKGROUND OF THE INVENTION

The invention relates to a hydraulic brake system with anti-lock control. An electronically controlled, hydraulic brake system includes a receptacle for electromagnetically controlled valves as well as a pump, driven by an electromotor which is provided as a return pump during slip control operation, to return brake fluid released from wheel brakes into one or more low-pressure accumulators in the direction of the master cylinder (TMC). In addition, an electronic control unit (ECU) is provided which is connect to an electrical network for power supply and to an electronic bus system for communication. Further, the electronic control unit is electrically connected with valve coils and wheel rotation sensors, as well as with a variable-speed electromotor.

During the slip control operation, the valves, in dependence on the prevailing wheel slip, will be initiated for a limited time in a way that pressure decrease, pressure holding, and pressure increase conditions can be caused in the wheel brakes. This is called pressure modulation in brief. To achieve a pressure decrease, for example, the respective outlet valve of a wheel brake opens, so that the discharged pressure fluid volume can temporarily reach a low-pressure accumulator. To ensure that the brake pedal remains in its directed position and does not suddenly drop toward the floor board due to the discharged volume, the return pump serves to push back the pressure fluid volume, discharged from the wheel brakes into the low-pressure accumulator, toward the master brake cylinder. The driver recognizes this event often frequently through pedal vibrations and the running noises of the electromotor, as well as through the running noises of the pump. Furthermore, pressure pulses as a result of abrupt valve opening and valve closing events are usually part of the previously mentioned repertoire.

It is already known from the EP 577 609 B1 to direct an electromotor to drive a limited-output return pump. According to DE 43 03 206 C2, it is suggested to set the conveying output of a return hydraulic pump in dependence on the estimated prevailing pressure in the brake system. To this purpose, it is possible to pre-set the rotational speed of the electric drive. In order to avoid the need to measure the prevailing pressure of the brake system separately with pressure sensors, a prevailing pressure estimate occurs by operating the electromotor by generator. To estimate the prevailing pressure, the electromotor is basically initiated with pulses and briefly switched to generator operation between the initiating pulses to determine the actual motor speed and prevailing pressure load from the generator voltage and its fading characteristics. This way, one receives information about the actually tapped wattage. Depending on the thus estimated prevailing pressure, the speed of the electromotor is adjusted.

From other publications it is known to control the speed of an ABS pump motor, for the purpose of noise reduction, by means of a closed-loop control circuit. The control circuit requires a speed sensor for the determination of the motor speed. This causes additional investment measures, which are not always possible.

It is the object of the present invention to fine-tune the pump actuation in a electro-hydraulic brake system in order to reduce uncomfortable brake pedal reactions and unnecessary noise harassment in the ABS return mode.

### SUMMARY OF THE INVENTION

The invention is based on the principal idea to refer to the filling level of at least one low-pressure accumulator as a criterion for nominal motor speed. This makes an adaptive pump control possible by adaptively—i.e. dependent on the prevailing parameters and demands—enabling a fast or slow draining of the low-pressure accumulator. It is provided to operate the electromotor at high or low speeds. In other words, in predetermined situations, it is possible to refrain from a particularly fast draining of a low-pressure accumulator. The changed pump strategy will be selected when indicated by the low-pressure accumulator volume to be drained.

This invention prevents a temporary overspeeding of the pump and uncomfortable brake pedal reactions due to interrupted fluid return. In other words, the conveying process is continuously performed in dependence on the above-mentioned influencing quantities, and thus the comfort during the pump operation is improved.

The filling level of the low-pressure accumulator can be measured directly or can be determined by means of other parameters—in other words, it can be estimated. It is recommended to use the pattern of the magnetic valve actuations, for example in regard to actuation times of the solenoid valves, especially valve current times and/or PWM-modulation patterns as a basis for the estimate, as far as switching valves are used with analogized control.

In a further preferred embodiment, the setting or control of the nominal motor speed occurs on the basis of a characteristic map, in which the parameters, driver applied prevailing pressure and low-pressure accumulator filling level, are entered together as input quantities. The characteristic map is storable in an electronic controller in a mathematical-parametric form of a matrix.

The characteristic map including the above-mentioned parameters, driver applied prevailing pressure (Pthx) and filling level (LPA_V_thy), can be formulated as follows. The nominal motor speed is stated by pump voltage (RPS=requested pump speed):

TABLE 1
Demanded pump speed (RPS) in dependence on TMC pressure
(p) and low-pressure accumulator volume (LPA_V)

| p/V | LPA_V_th₁ (min) | LPA_V_th₂ | LPA_V_th₃ (max |
|---|---|---|---|
| p_th₁ (min) | RPSₘᵢₙ | RPS₁₂ | RPS₁₃ |
| p_th₂ | RPS₂₁ | RPS₂₂ | RPS₂₃ |
| p_th₃ (max) | RPS₃₁ | RPS₃₂ | RPSₘₐₓ |

### BRIEF DESCRIPTION OF THE DRAWINGS

In the drawings,

FIG. 1 shows a characteristic map according to table 1.

FIG. 2 shows a flow diagram of a method according to the invention with the filling level of the low-pressure accumulator and the driver-induced prevailing pressure as input quantities.

### DETAILED DESCRIPTION OF THE DRAWINGS

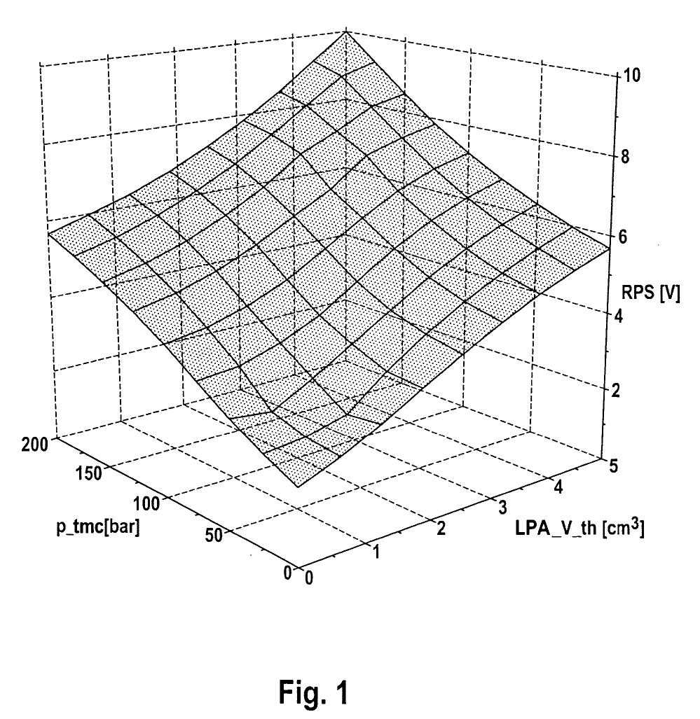

In FIG. 1, a characteristic map according to table 1 is graphically illustrated. The corresponding demanded motor speed is illustrated in the coordinates as a tilted plane. At the same time, the motor speed—set according to the results of the input quantities—is divided into 5 different speed ranges.

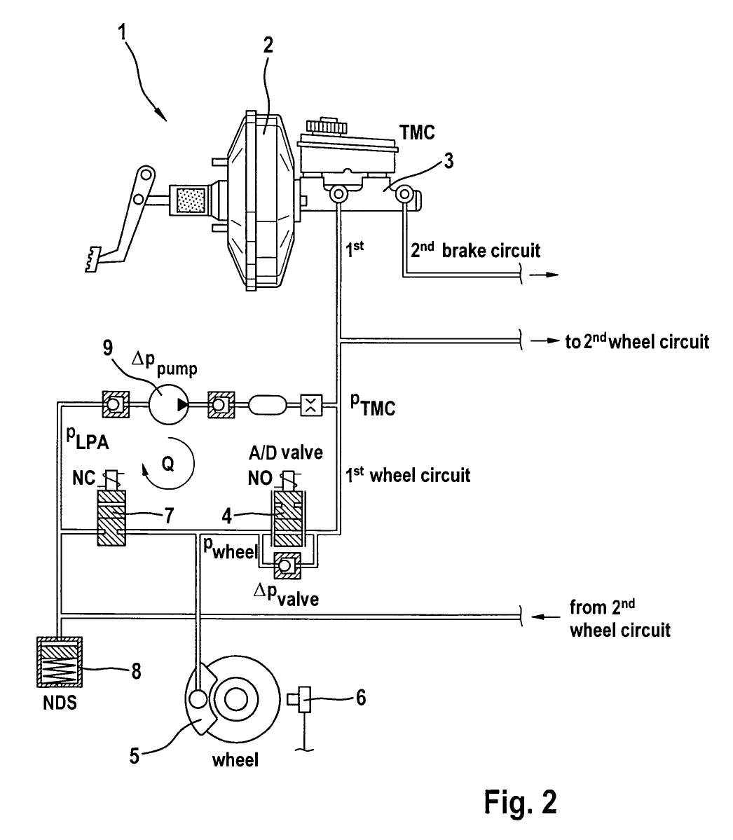

FIG. 2 illustrates the process as a flow diagram by means of a modification in which the filling level of the low-pressure accumulator as well as the driver-induced prevailing pressure in the master cylinder are provided as input quantities. The figure describes the structure and the diagram of the hydraulic brake system in a simplified example of only one brake circuit with just one wheel brake.

In reference to FIG. 2 an actuator unit 1 is provided with a brake force booster 2 and a master cylinder 3, TMC, which, with its pressure chamber via a normally open inlet valve 4, is hydraulically connected to a wheel brake 5. The electronic controller is not illustrated. A pressure sensor can be provided to detect the pressure in the pressure chamber (prevailing pressure) of the master cylinder 3. The actuator unit 1 enables a pressure build-up in wheel brake 5 for braking. The wheel rotation behavior is detected with a symbolically illustrated wheel sensor 6. On an outlet side, the wheel brake 5 is equipped with a normally closed outlet valve 7, which is connected to a low-pressure accumulator 8. The low-pressure accumulator is attached to a suction side of an electromotorically driven hydraulic pump 9, which on the delivery side is connected with a hydraulic line, linking the master cylinder 3 with the wheel brake 5.

This arrangement enables a pressure modulation, in which, for example, inlet valve 4 is closed and outlet valve 7 is opened, and hydraulic pressure is discharged from wheel brake 5, thus pressure fluid can flow into the low-pressure accumulator 8.

The discharged pressure fluid is returned by the hydraulic pump 9 in the direction of master cylinder 3 in front of the wheel brake 5. This prevents a drop of the brake pedal and an exhaustion of the pressure fluid (closed system). It is understood that in the drawn circuit principally another wheel brake is provided and that there is also a second brake circuit with two wheel brakes.

In the brake system, the nominal electromotor speed is set or controlled depending on filling level in at least one of the low-pressure accumulators 8. For this purpose, the filling level in the low-pressure accumulator 8 is measured directly, for instance with the help of a sensor, such as particularly a displacement sensor at the low-pressure accumulator 8. Output signals of the sensor are supplied to the electronic controller by wire or in a wireless way.

According to another variation of the present invention, the filling level of the low-pressure accumulator 8 is established—in other words, estimated. This occurs with the help of the electronic controller by means of the valve actuation patterns emitted by the electronic controller for the actuation of the valves 4, 7. In other words, the valve actuation patterns are observed and evaluated, and by means of these findings conclusions are drawn about the size of the volume in the low-pressure accumulator 8. This measured or established filling level of the low-pressure accumulator serves to set or control the nominal electromotor speed. The comfort is improved if during a slip control the filling level of the low-pressure accumulator is periodically re-measured or re-established for the purpose of updating and is processed in the electronic controller.

A further enhancement of comfort and precision is achieved, if additionally the driver-induced prevailing pressure p_thx is referred to as a criterion for the nominal electromotor speed. The driver-induced prevailing pressure can either be directly detected by a pressure sensor or estimated on the basis of a model.

In connection with these data, an open-loop or closed-loop control of the nominal motor speed (requested pump speed RPS) in a type of characteristic map is made possible in dependence on the driver-induced prevailing pressure (P_thx) and on the low-pressure accumulator filling level LPA_V_thy.

Thus, it is made possible to drive the hydraulic pump 9 as needed. A temporary overspeeding of hydraulic pump 9, as recorded with brake systems of the prior art, will be avoided. The adjusted, in other words, smoothed conveying output of the hydraulic pump 9 improves the accuracy of the deducted models (low-pressure accumulator model) which refer to the conveying behavior.

What is claimed is:

1. A hydraulic brake system with anti-lock brake control comprising
an at least indirectly driver-actuated master cylinder
a plurality of wheel brakes (5),
at least one low-pressure accumulator (8), which is suitable to temporarily accommodate pressure fluid discharged from the wheel brakes (5) during a slip-controlled braking,
a hydraulic pump (9) to drain the at least one low-pressure accumulator (8),
a variable-speed electromotor for driving the hydraulic pump (9),
an electronic controller and solenoid valves (4, 7) to modulate the brake pressure in the wheel brakes (5) of slip-controlled wheels individually for each wheel dependent on wheel rotation behavior,
wherein the electronic controller comprises a module to change a nominal speed of the electromotor, in dependence on the filling level in the at least one of the low-pressure accumulators (8).

2. The hydraulic brake system as claimed in claim 1, wherein the (8) filling level of the low-pressure accumulator is measured.

3. The hydraulic brake system as claimed in claim 2, wherein a sensor is provided at the low-pressure accumulator (8) to measure its filling level, the sensor supplying output signals to the electronic controller.

4. The hydraulic brake system as claimed in claim 1, wherein a computing instruction is stored in the electronic controller, which, under consideration of valve actuations during a slip control, performs an estimation of the filling level of the low-pressure accumulator (8), and sets or controls a nominal speed of the electromotor in dependence on the estimated filling level of the at least one low-pressure accumulator (8).

5. The hydraulic brake system as claimed in claim 4, wherein the filling level of the low-pressure accumulator (8) is periodically updated during a slip control and that the updated filling level is processed in the electronic controller.

6. The hydraulic brake system as claimed in claim 1, wherein another criterion for changing the speed of the electromotor is a driver-induced prevailing pressure in the master cylinder (3).

7. The hydraulic brake system as claimed in claim 6, wherein the module contains a characteristic map establishing nominal speed values in dependence on the filling level (LPA_V_th) of the low-pressure accumulator as well as in dependence on the driver-induced prevailing pressure (p_TMC).
